(19) United States
(12) Patent Application Publication
(10) Pub. No.: US 2023/0066180 A1
(43) Pub. Date: Mar. 2, 2023

(54) CUTTING BLADE AND HAIR REMOVAL DEVICE

(71) Applicant: The Gillette Company LLC, Boston, MA (US)

(72) Inventors: Peter Bodo Gluche, Bellenberg (DE); Ralph Gretzschel, Neu-Ulm (DE); Michael Mertens, Vöhringen/Illerberg (DE)

(21) Appl. No.: 17/965,998

(22) Filed: Oct. 14, 2022

Related U.S. Application Data
(63) Continuation of application No. PCT/EP2021/059194, filed on Apr. 8, 2021.

(30) Foreign Application Priority Data
Apr. 16, 2020 (EP) 20169927.9

(51) Int. Cl. B26B 21/56

(52) U.S. Cl. CPC B26B 21/56

(57) ABSTRACT

The present invention relates to a cutting blade having an asymmetric cross-sectional shape with a first face, a second face opposed to the first face and different from the first face as well as a cutting edge wherein the first face comprises a surface and the second face comprises a primary bevel, a secondary bevel and a tertiary bevel with a first wedge angle θ₁ between the surface on the first face and the primary bevel, a second wedge angle θ₂ between the surface on the first face and the secondary bevel and a third wedge angle θ₃ between the surface on the first face and the tertiary bevel. Moreover, the present invention relates to a hair removal device comprising this cutting blade.

### FIELD OF THE INVENTION

The present invention relates to a shaving device for shaving a skin surface with improved cutting blades and geometry.

### BACKGROUND OF THE INVENTION

Cutting blades, in particular razor blades, are typically made out of a suitable substrate material such as stainless steel in which a symmetric wedge-shaped cutting edge is formed.

With respect to razor blades, the design of the cutting blade has to be optimized to find the best compromise between the sharpness of the blade and the mechanical strength and hence durability of the cutting edge. The fabrication of conventional stainless steel razor blades involves a hardening treatment of the steel substrates before the blade is sharpened from both sides to form a symmetric cutting edge usually by grinding the hardened steel substrate.

A further coating may be applied to the steel blade after sharpening to optimize the mechanical properties of the blades. Hard coating materials such as diamond, amorphous diamond, diamond-like carbon (DLC), nitrides, carbides, or oxides are suitable to improve the mechanical strength of the cutting edge.

Thus, the harder the cutting edge material, the longer the edge holding property and in consequence the less wear is expected. Other coatings may be applied to increase the corrosion resistance or reduce the blade friction.

Most blades in the prior art are focused on blades with a symmetric blade body. However, some approaches exist where blades with an asymmetric blade are taught.

In U.S. Pat. No. 3,606,682, a razor blade with improved cutting ease and shaving comfort is described. The blade has a recessed portion adjacent to the cutting edge which allows an improved shaving comfort. This effect is shown for symmetric and asymmetric blade bodies.

U.S. Pat. No. 3,292,478 describes a cutting die knife for textiles, leather and similar sheet materials wherein the knife has suitably inclined surfaces on both sides with the consequence that the cutting edge is not positioned centrally between the side surfaces and the knife has an asymmetric shape.

U.S. Pat. No. 3,514,856 refers to a razor blade construction having defined angular and dimensional limits of the converting surfaces from the cutting edge and an effective recessed portion immediately adjacent thereto from proved cutting ease and shaving comfort.

There is a continuing desire to reduce the force needed to cut an object, since this requires less energy and creates less wear of the cutting edge. In the context of shaving, cutting hairs at lower forces results in less pulling on the hairs and hence less discomfort.

However, making the edge sharper also makes it more fragile and despite the application of hard coatings, the durability of conventional steel razor blades is still limited today.

The present invention therefore addresses the mentioned drawbacks in the prior art and to provide cutting blades with a design which allow at the same time, a high comfort during the cutting process, i.e., a low cutting force, and a high durability, i.e., a low fragility of the blade.

### SUMMARY OF THE INVENTION

The present invention is directed to a cutting blade having a first face, a second face opposed to the first face and different from the first face as well as a cutting edge at the intersection of the first face and the second face, wherein the first face comprises a first surface and the second face comprises a primary bevel, a secondary bevel and a tertiary bevel with the primary bevel extending from the cutting edge to the secondary bevel, the secondary bevel extending from the primary bevel to the tertiary bevel, a first intersecting line connecting the primary bevel and the secondary bevel, and a second intersecting line connecting the secondary bevel and the tertiary bevel.

In other aspects, the present invention is directed to a first wedge angle θ₁ between the first surface and the primary bevel, a second wedge angle θ₂ between the first surface and the secondary bevel, a third wedge angle θ₃ between the first surface and the tertiary bevel, the primary bevel having a length d₁ being the dimension projected onto the first surface and/or the imaginary extension of the first surface taken from the cutting edge to the first intersecting line from 0.1 to 7 μm, a length d₂ being the dimension projected onto the first surface taken from the cutting edge to the second intersecting line from 1 to 150 μm, wherein θ₁>θ₂ and θ₂<θ₃.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a perspective view of a first cutting blade in accordance with the present invention.

FIG. 2 is a cross-sectional view of the cutting blade according to FIG. 1

FIG. 3 is a cross-sectional view of a further cutting blade in accordance with the present invention.

FIG. 4 is a cross-sectional view of a further cutting blade in accordance with the present invention with a second material.

FIG. 5 is a cross-sectional view of a further cutting blade in accordance with the present invention with an additional bevel on the first face.

FIG. 6 is a perspective view of a further cutting blade in accordance with the present invention with a non straight cutting edge consisting of curved segments.

FIG. 7 are flow charts of the process for manufacturing the cutting blades

FIG. 8 is a schematic cross sectional view of a round tip showing the determination of the tip radius.

FIG. 9 is a microscopic image of a cutting blade according to the present invention.

The following reference signs are used in the figures of the present application.

Reference sign list

| | |
|---|---|
| 1 | blade |
| 2 | first face |
| 3 | second face |
| 4 | cutting edge |
| 5 | primary bevel |
| 6 | secondary bevel |
| 7 | tertiary bevel |
| 9 | first surface |
| 9′ | imaginary extension of |
| | the first surface |
| 10 | first intersecting line |
| 11 | second intersecting line |
| 15 | blade body |
| 18 | first material |
| 19 | second material |
| 20 | boundary surface |
| 60 | bisecting line |
| 61 | perpendicular line |
| 62 | circle |
| 65 | construction point |
| 66 | construction point |
| 67 | construction point |
| 260 | bisecting line |

### DETAILED DESCRIPTION OF THE INVENTION

The present invention relates to a cutting blade having an asymmetric cross-sectional shape with a first face, a second face opposed to the first face and different from the first face as well as a cutting edge wherein the first face comprises a surface and the second face comprises a primary bevel, a secondary bevel and a tertiary bevel with a first wedge angle θ₁ between the surface on the first face and the primary bevel, a second wedge angle θ₂ between the surface on the first face and the secondary bevel and a third wedge angle θ₃ between the surface on the first face and the tertiary bevel. Moreover, the present invention relates to a hair removal device comprising this cutting blade.

The following definitions are used in the present application:
the rake face is the surface of a cutting blade over which the cut hair slides that is removed in the cutting process
the clearance face is the surface of a cutting tool that passes over the skin;

the angle between the clearance face and the contacting surface to the skin is the clearance angle α
The cutting bevel of a cutting blade is enclosed by the rake face and the clearance face and denoted by the bevel angle θ
The cutting edge is the line of intersection of the rake face and the clearance face

The present invention is directed to a cutting blade having a first face, a second face opposed to the first face and different from the first face as well as a cutting edge at the intersection of the first face and the second face, wherein the first face comprises a first surface and the second face comprises a primary bevel, a secondary bevel and a tertiary bevel with the primary bevel extending from the cutting edge to the secondary bevel, the secondary bevel extending from the primary bevel to the tertiary bevel, a first intersecting line connecting the primary bevel and the secondary bevel, a second intersecting line connecting the secondary bevel and the tertiary bevel, a first wedge angle θ₁ between the first surface and the primary bevel, a second wedge angle θ₂ between the first surface and the secondary bevel, a third wedge angle θ₃ between the first surface and the tertiary bevel, the primary bevel having a length d₁ being the dimension projected onto the first surface and/or the imaginary extension of the first surface taken from the cutting edge to the first intersecting line from 0.1 to 7 μm, a length d₂ being the dimension projected onto the first surface taken from the cutting edge to the second intersecting line from 1 to 150 μm, wherein θ₁>θ₂ and θ₂<θ₃.

This problem is solved by the cutting blade with the features of claim 1 and the hair removal device with the features of claim 16. The further dependent claims define preferred embodiments of such a blade.

The term “comprising” in the claims and in the description of this application has the meaning that further components are not excluded. Within the scope of the present invention, the term “consisting of” should be understood as preferred embodiment of the term “comprising”. If it is defined that a group “comprises” at least a specific number of components, this should also be understood such that a group is disclosed which “consists” preferably of these components.

In the following, the term “cross-sectional view” refers to a view of a slice through the cutting element perpendicular to the cutting edge (if the cutting edge is straight) or perpendicular to the tangent of the cutting edge (if the cutting edge is curved) and perpendicular to the surface of the substrate of the cutting element.

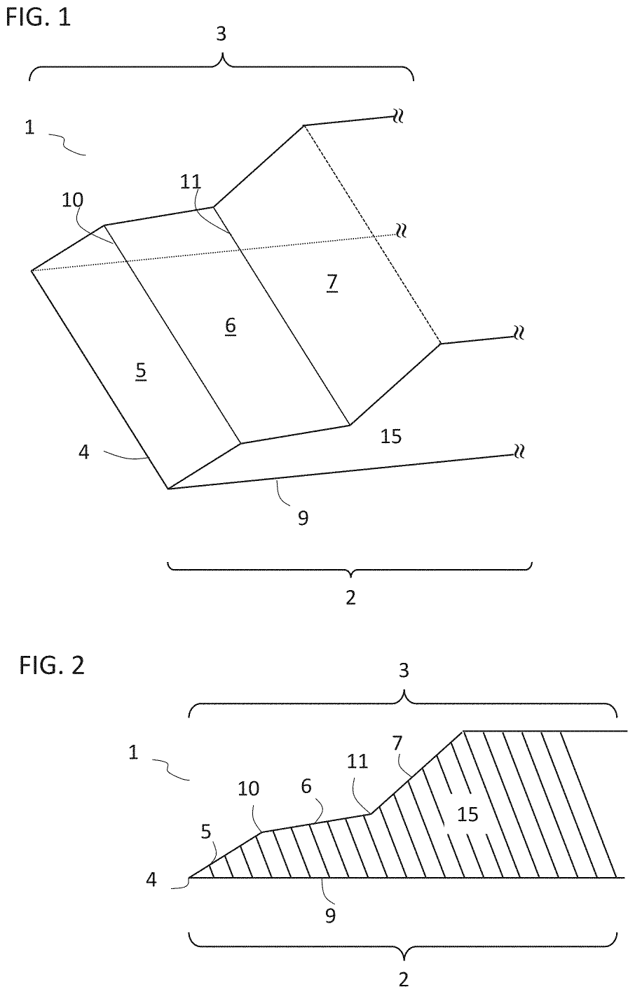

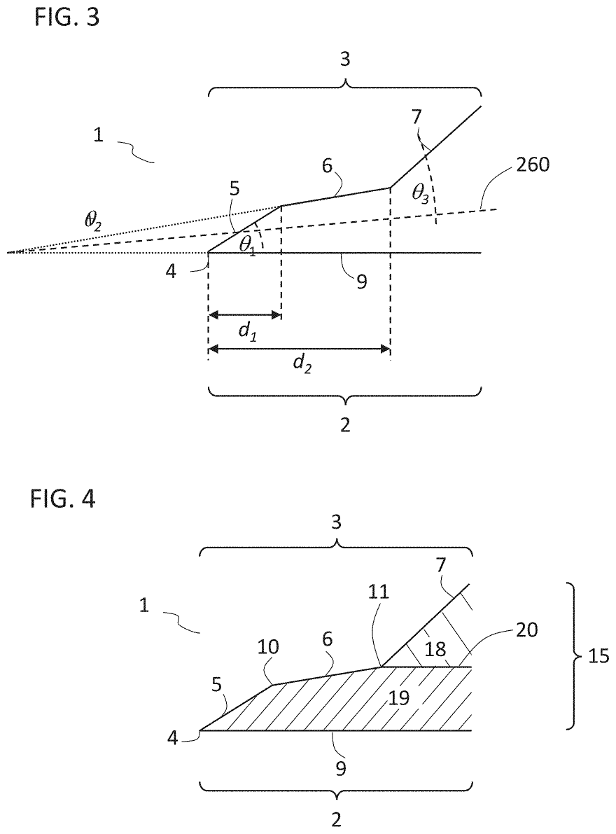

The term “intersecting line” is understood herein as the linear extension of an intersecting point (according to a cross-sectional view as in FIG. 3) between different bevels regarding the perspective view (as in FIG. 1). As an example, if a straight bevel is adjacent to a straight bevel the intersecting point of the cross-sectional view is extended to an intersecting line in the perspective view.

According to the present invention a cutting blade is provided having a first face, a second face opposed to the first face and different from the first face as well as and a cutting edge wherein:
the first face comprises a first surface and
the second face comprises a primary bevel, a secondary bevel and a tertiary bevel with
   the primary bevel extending from the cutting edge to the secondary bevel;
   the secondary bevel extending from the primary bevel to the tertiary bevel;
   a first intersecting line connecting the primary bevel and the secondary bevel; and
   a second intersecting line connecting the secondary bevel and the tertiary bevel;
   a first wedge angle θ₁ between the first surface and the primary bevel; and
   a second wedge angle θ₂ between the first surface and the secondary bevel; and
   a third wedge angle θ₃ between the first surface and the tertiary bevel; and
   the primary bevel having a length d₁ being the dimension projected onto the first surface (9) and/or the imaginary extension of the first surface (9′) taken from the cutting edge (4) to the first intersecting line (10) from 0.1 to 7 μm,
   a length d₂ being the dimension projected onto the first surface taken from the cutting edge to the second intersecting line from 1 to 75 μm.

It was surprisingly found that a cutting blade with a very stable cutting edge together with a very good cutting performance can be provided when the wedge angles fulfill the following conditions:

θ₁>θ₂ and θ₂<θ₃.

The cutting blades according to the present invention have low cutting force due to a thin secondary bevel with a low wedge angle.

The cutting blades according to the present invention are strengthened by adding a primary bevel with a primary wedge angle greater than the secondary wedge angle. The primary bevel with the first wedge angle θ₁ has therefore the function to stabilize the cutting edge mechanically against damage from the cutting operation which allows a slim blade body in the area of the secondary bevel without affecting the cutting performance of the blade.

The cutting blades according to the present invention are even mechanically stronger by reducing the length of the thin secondary bevel to a fraction of the thickness of the object to be cut and employing the secondary wedge for penetrating the object to be cut which allows a reduction of the cutting force of the cutting blade. The secondary bevel with the second wedge angle θ₂ therefore has the function of penetrating the object to be cut. By using the primary bevel with the wedge angle θ₁ to stabilize the cutting edge the second wedge angle θ₂ can be reduced.

The cutting blades according to the present invention are further strengthened by adding a thick and strong tertiary bevel that has a tertiary wedge angle greater than the secondary wedge angle and by employing this tertiary bevel to split the object to be cut, thus reducing the forces acting on the thin secondary bevel. For this function the third wedge angle θ₃ must be larger than the second wedge angle θ₂. The third wedge angle θ₃ represents the splitting angle, i.e., the angle necessary to split the object to be cut. For this function the third wedge angle θ₃ must be larger than the second wedge angle θ_{2.}

According to a preferred embodiment, the cutting blade has an asymmetric crosssectional shape. The asymmetrical cross-sectional shape refers to the symmetry with respect to an axis which is the bisecting line of the secondary wedge angle θ₂ and anchored at the cutting edge.

In a preferred embodiment of the invention the primary and secondary bevel are formed within a hard coating material to increase their mechanical strength further and the tertiary bevel is formed from a substrate material. Such an asymmetric cutting edge may lower the friction at the bevel side (conical shape) due to a reduction of the contact area between the second face and the hair.

According to a first preferred embodiment, the first wedge angle θ₁ ranges from 5° to 75°, preferably 10° to 60°, more preferably 15° to 46°, and even more preferably 20° to 45° and/or the second wedge angle θ₂ ranges from −5° to 40°, preferably 0° to 30°, more preferably 5° to 25°, even more preferably 10 to 15° and/or the third wedge angle θ₃ ranges from 1° to 60°, preferably 10° to 55°, more preferably 19° to 46°, and most preferably is 45°.

According to a further preferred embodiment, the primary bevel has a length di being the dimension projected onto the first surface and/or the imaginary extension of the first surface taken from the cutting edge to the first intersecting line from 0.5 to 5 μm, and preferably 1 to 3 μm. A length d₁<0.1 μm is difficult to produce since an edge of such length is too fragile and would not allow a stable use of the cutting blade. It has been surprisingly found that the primary bevel stabilizes the blade body with the secondary and tertiary bevel which allows a slim blade in the area of the secondary bevel which offers a low cutting force. On the other hand, the primary bevel does not affect the cutting performance provided the length d₁ is not larger than 7 μm.

Preferably, the length d₂ being the dimension projected onto the first surface and/or the imaginary extension of the first surface taken from the cutting edge to the second intersecting line ranges from 5 to 100 μm, and more preferably from 10 to 75 um and even more preferably from 15 to 50 μm. The length d₂ corresponds to the penetration depth of the cutting blade in the object to be cut. In general, d₂ corresponds to at least 30% of the diameter of the object to be cut, i.e., when the object is human hair which typically has a diameter of around 100 μm the length d₂ is around 30 μm.

The cutting blade is preferably defined by a blade body comprising or consisting of a first material and a second material joined with the first material. The second material can be deposited as a coating at least in regions of the first material, i.e., the second material can be an enveloping coating of the first material or a coating deposited on the first material on the first face.

The material of the first material is in general not limited to any specific material as long it is possible to bevel this material.

However, according to an alternative embodiment the blade body comprises or consists only of the first material, i.e., an uncoated first material. In this case, the first material is preferably a material with an isotropic structure, i.e., having identical values of a property in all directions. Such isotropic materials are often better suited for shaping, independent from the shaping technology.

The first material preferably comprises or consists of a material selected from the group consisting of:
metals, preferably titanium, nickel, chromium, niobium, tungsten, tantalum, molybdenum, vanadium, platinum, germanium, iron, and alloys thereof, in particular steel,
ceramics comprising at least one element selected from the group consisting of carbon, nitrogen, boron, oxygen or combinations thereof, preferably silicon carbide, zirconium oxide, aluminum oxide, silicon nitride, boron nitride, tantalum nitride, AlTiN, TiCN, TiAlSiN, TiN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face, wafer orientation <100>, <110>, <111>or <211>,
single crystalline materials,
glass or sapphire,
polycrystalline or amorphous silicon or germanium,
mono- or polycrystalline diamond, nano-crystalline and/or ultranano-cystalline diamond like carbon (DLC), adamantine carbon and
combinations thereof.

The steels used for the first material are preferably selected from the group consisting of 1095, 12C27, 14C28N, 154CM, 3Cr13MoV, 4034, 40X10C2M, 4116, 420, 440A, 440B, 440C, 5160, 5Cr15MoV, 8Cr13MoV, 95X18, 9Cr18MoV, Acuto+, ATS-34, AUS-4, AUS-6 (=6A), AUS-8 (=8A), C75, CPM-10V, CPM-3V, CPM-D2, CPM-M4, CPM-S-30V, CPM-S-35VN, CPM-S-60V, CPM-154, Cronidur-30, CTS 204P, CTS 20CP, CTS 40CP, CTS B52, CTS B75P, CTS BD-1, CTS BD-30P, CTS XHP, D2, Elmax, GIN-1, H1, N690, N695, Niolox (1.4153), Nitro-B, S70, SGPS, SK-5, Sleipner, T6MoV, VG-10, VG-2, X-15T.N., X50CrMoV15, ZDP-189.

It is preferred that the second material comprises or consists of a material selected from the group consisting of :
oxides, nitrides, carbides, borides, preferably aluminum nitride, chromium nitride, titanium nitride, titanium carbon nitride, titanium aluminum nitride, cubic boron nitride
boron aluminum magnesium
carbon, preferably diamond, poly-crystalline diamond, nano-crystalline diamond, diamond like carbon (DLC), and
combinations thereof.

The second material may be preferably selected from the group consisting of TiB₂, AlTiN, TiAlN, TiAlSiN, TiSiN, CrAl, CrAlN, AlCrN, CrN, TiN,TiCN and combinations thereof.

Moreover, all materials cited in the VDI guideline 2840 can be chosen for the second material.

It is particularly preferred to use a second material of nano-crystalline diamond and/or multilayers of nano-crystalline and polycrystalline diamond as second material. Relative to monocrystalline diamond, it has been shown that production of nano-crystalline diamond, compared to the production of monocrystalline diamond, can be accomplished substantially more easily and economically. Moreover, with respect to their grain size distribution nano-crystalline diamond layers are more homogeneous than polycrystalline diamond layers, the material also shows less inherent stress. Consequently, macroscopic distortion of the cutting edge is less probable.

It is preferred that the second material has a thickness of 0.15 to 20 μm, preferably 2 to 15 μm and more preferably 3 to 12 μm.

It is preferred that the second material has a modulus of elasticity (Young's modulus) of less than 1200 GPa, preferably less than 900 GPa, more preferably less than 750 GPa and even more preferably less than 500 GPa. Due to the low modulus of elasticity the hard coating becomes more flexible and more elastic and may be better adapted to the object or the contour to be cut. The Young's modulus is determined according to the method as disclosed in Markus Mohr et al., “Youngs modulus, fracture strength, and Poisson's ratio of nanocrystalline diamond films”, J. Appl. Phys. 116, 124308 (2014), in particular under paragraph III. B. Static measurement of Young's modulus.

The second material has preferably a transverse rupture stress σ₀ of at least 1 GPa, more preferably of at least 2.5 GPa, and even more preferably at least 5 GPa.

With respect to the definition of transverse rupture stress Go, reference is made to the following literature references:
R. Morrell et al., Int. Journal of Refractory Metals & Hard Materials, 28 (2010), p. 508 -515;

R. Danzer et al. in “Technische keramische Werkstoffe”, published by J. Kriegesmann, HvB Press, Ellerau, ISBN 978-3-938595-00-8, chapter 6.2.3.1 “Der 4-Kugelversuch zur Ermittlung der biaxialen Biegefestigkeit sproder Werkstoffe”

The transverse rupture stress σ₀ is thereby determined by statistical evaluation of breakage tests, e.g., in the B3B load test according to the above literature details. It is thereby defined as the breaking stress at which there is a probability of breakage of 63%.

Due to the extremely high transverse rupture stress of the second material the detachment of individual crystallites from the hard coating, in particular from the cutting edge, is almost completely suppressed. Even with long-term use, the cutting blade therefore retains its original sharpness.

The second material has preferably a hardness of at least 20 GPa. The hardness is determined by nanoindentation (Yeon-Gil Jung et. al., J. Mater. Res., Vol. 19, No. 10, p. 3076).

The second material has preferably a surface roughness R_{RMS} of less than 100 nm, more preferably less than 50 nm, and even more preferably less than 20 nm, which is calculated according to

$${R}_{R M S} = ( \frac{1}{A} ) \int \int {Z ( x , y )}^{2} d x d y$$

A=evaluation area

Z(x,y)=the local roughness distribution

The surface roughness RRms is determined according to DIN EN ISO 25178. The mentioned surface roughness makes additional mechanical polishing of the grown second material superfluous.

In a preferred embodiment, the second material has an average grain size d₅₀ of the nano-crystalline diamond of 1 to 100 nm, preferably 5 to 90 nm more preferably from 7 to 30 nm, and even more preferably 10 to 20 nm. The average grain size d₅₀ is the diameter at which 50% of the second material is comprised of smaller partides. The average grain size d₅₀ may be determined using X-ray diffraction or transmission electron microscopy and counting of the grains.

It is preferred that the first material and/or the second material is/are coated at least in regions with a low-friction material, preferably selected from the group consisting of fluoropolymers (like PTFE), parylene, polyvinylpyrrolidone, polyethylene, polypropylene, polymethyl methacrylate, graphite, diamond-like carbon (DLC) and combinations thereof.

The intersecting line connecting the primary bevel and the secondary bevel is preferably shaped within the second material.

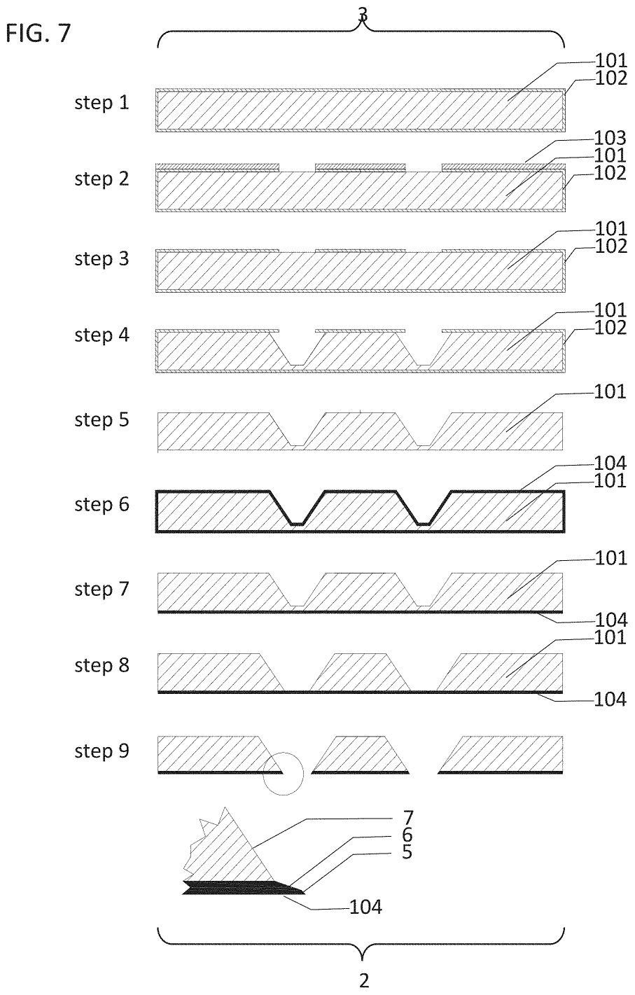

It is further preferred that the intersecting line between secondary and tertiary bevel is arranged at the boundary surface of the first material and the second material which makes the process of manufacture easier to handle and therefore more economic, e.g., the blades can be manufactured according to the process of FIG. 7.

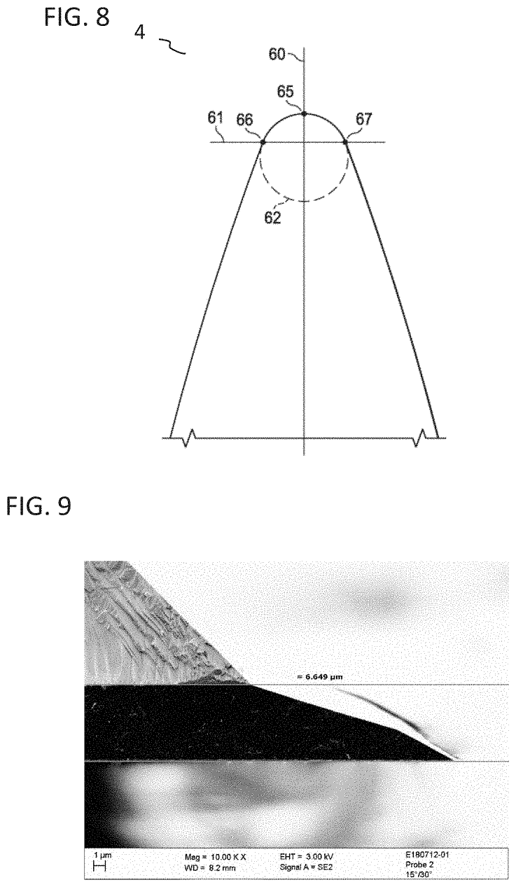

The cutting edge ideally has a round configuration which improves the stability of the blade. The cutting edge has preferably a tip radius of less than 200 nm, more preferably less than 100 nm and even more preferably less than 50 nm, determined e.g., by cross sectional SEM using the method illustrated in FIG. 8.

It is preferred that the tip radius r of the cutting edge correlates with the average grain size d₅₀ of the hard coating. It is hereby advantageous if the ratio between the rounded radius r of the second material at the cutting edge and the average grain size d₅₀ of the nano-crystalline diamond hard coating r/d₅₀ is from 0.03 to 20, preferably from 0.05 to 15, and particularly preferred from 0.5 to 10.

The first face preferably further comprises a quaternary bevel which extends from the cutting edge to the first surface. If the first face corresponds to the clearance face this quaternary bevel will improve the comfort of the cutting, i.e., for shaving.

In a preferred embodiment, the first face corresponds to the clearance face and the second face corresponds to the rake face of the cutting blade. However, it is also possible to use the first face as the rake face and the second face as the clearance face.

In particular, the cutting blade can be configured as a knife blade, razor blade, scalpel, knife, machine knife in slitting-, burst- and crash cutting systems, scissors or shear cutting systems or can be used as such. Likewise, it is possible that the cutting blade is configured as a shaving system, i.e., as a head with a plurality of razor blades or can be used as such. All the razor blades are thereby configured as a cutting blade according to the present invention.

Hence, according to the present invention also a hair removal device comprising a cutting blade as described above is provided.

### DETAILED DESCRIPTION OF THE INVENTION

FIG. 1 is a perspective view of the cutting blade according to the present invention.

This cutting blade 1 has a blade body 15 which comprises a first face 2 and a second face 3 which is opposed to the first face 2. At the intersection of the first face 2 and the second face 3 a cutting edge 4 is located. The cutting edge 4 is shaped straight or substantially straight. The first face 2 comprises a plane first surface 9 while the second surface 3 is segmented in different bevels.

The second face 3 comprises a primary bevel 5, a secondary bevel 6 and a tertiary bevel 7. The primary bevel 5 is connected via a first intersecting line 10 with the secondary bevel 6 which on the other end is connected to the tertiary bevel 7 via a second intersecting line 11. In FIG. 2, the cross-sectional view of the cutting blade of FIG. 1 is shown.

In FIG. 3, a further cross-sectional view of the cutting blade according to the present invention is shown. This cutting blade 1 has a blade body which comprises a first face 2 and a second face 3 which is opposed to the first face 2. At the intersection of the first face 2 and the second face 3 a cutting edge 4 is located. The first face 2 comprises a plane first surface 9 while the second face 3 is segmented in different bevels. The second face 3 of the cutting blade 1 has a primary bevel 5 with a first wedge angle θ₁ between the first surface 9 and the primary bevel 5. The secondary bevel 6 has a second wedge angle θ₂ between the first surface 9 and the secondary bevel 6 with a bisecting line 260 of the secondary wedge angle θ₂ and anchored at the cutting edge 4. θ₂ is smaller than θ₁. The tertiary bevel 7 has a third wedge angle θ₃ which is larger than θ₂. The primary bevel 5 has a length d₁ being the dimension projected onto the first surface 9 which is in the range from 0.5 to 5 μm. The primary bevel 5 and the secondary bevel 6 together have a length d₂ being the dimension projected onto the first surface 9 which is in the range from 1 to 150 um, preferably 5 to 100 μm.

In FIG. 4, a further sectional view of a cutting blade of the present invention is shown where the blade body 15 comprises a first material 18, e.g., silicon, with a second material 19, e.g., a diamond layer on the first material 18 at the first face 2. The primary bevel 5 and secondary bevel 6 are located in the second material 19 while the tertiary bevel 7 is located in the first material 18. The first material 18 and the second material 19 are joined along a boundary surface 20.

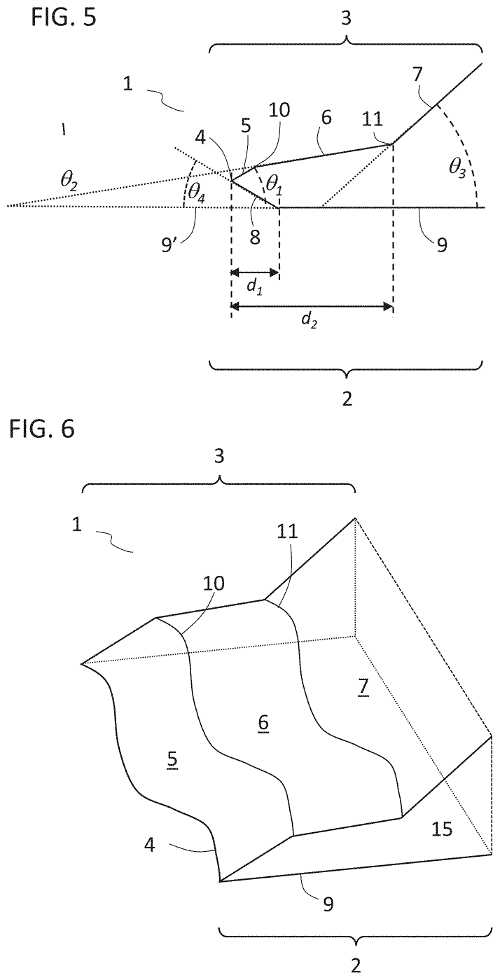

FIG. 5 shows an embodiment according to the present invention of a cutting blade 1 with a first face 2 and a second face 3. The second face 3 has a primary bevel 5, a secondary bevel 6 and a tertiary bevel 7. On the first face 2 between the surface 9 and the cutting edge 4, a further quaternary bevel 8 is located. The angle between the quaternary bevel 8 and the surface 9 is θ₄. The wedge angle θ₂ between the primary bevel 5 and the surface 9 is smaller than the wedge angle θ₁ between the secondary bevel 6 and the surface 9. Moreover, the wedge angle θ₃ between the tertiary bevel 7 and the surface 9 is larger than θ₂.

In FIG. 6 a perspective view of a further cutting blade according to the present invention is shown. The cutting blade 1 has a blade body 15 which comprises a first face 2 and a second face 3 which is opposed to the first face 2. A cutting edge 4 is located at the intersection of the first face 2 and the second face 3 and is shaped not straight but consisting of curved segments. The first face 2 comprises a planar surface 9 while the second surface 3 is segmented in a primary bevel 5, a secondary bevel 6 and a tertiary bevel 7. The primary bevel 5 is connected via an intersecting line 10 with the secondary bevel 6 which on the other end is connected to the tertiary bevel 7 via an intersecting line 11. The intersecting lines 10 and 11 follow the shape of the cutting edge 4 and are therefore shaped not straight but consisting of curved segments as well.

In FIG. 7 a flow chart of the inventive process is shown. In a first step 1, a silicon wafer 101 is coated by PE-CVD or thermal treatment (low pressure CVD) with a silicon nitride (Si₃N₄) layer 102 as protection layer for the silicon. The layer thickness and deposition procedure must be chosen carefully to enable sufficient chemical stability to withstand the following etching steps. In step 2, a photoresist 103 is deposited onto the Si₃N₄ coated substrate and subsequently patterned by photolithography. The (Si₃N₄) layer is then structured by e.g., CF₄-plasma reactive ion etching (RIE) using the patterned photoresist as mask. After patterning, the photoresist 103 is stripped by organic solvents in step 3. The remaining, patterned Si₃N₄ layer 102 serves as a mask for the following pre-structuring step 4 of the silicon wafer 101 e.g., by anisotropic wet chemical etching in KOH. The etching process is ended when the structures on the second face 3 have reached a predetermined depth and a continuous silicon first face 2 remains. Other wet- and dry chemical processes may be suited, e.g., isotropic wet chemical etching in HF/HNO₃ solutions or the application of fluorine containing plasmas. In the following step 5, the remaining Si₃N₄ is removed by, e.g., hydrofluoric acid (HF) or fluorine plasma treatment. In step 6, the pre-structured Si-substrate is coated with an approx. 10 μm thin diamond layer 104, e.g., nano-crystalline diamond. The diamond layer 104 can be deposited onto the pre-structured second surface 3 and the continuous first surface 2 of the Si-wafer 101 (as shown in step 6) or only on the continuous first surface 2 of the Si-wafer (not shown here). In the case of double-sided coating, the diamond layer 104 on the structured second surface 3 has to be removed in a further step 7 prior to the following edge formation steps 9-11 of the cutting blade. The selective removal of the diamond layer 104 is performed e.g., by using an Ar/O₂-plasma (e.g., RIE or ICP mode), which shows a high selectivity towards the silicon substrate. In step 8, the silicon wafer 101 is thinned so that the diamond layer 104 is partially free standing without substrate material and the desired substrate thickness is achieved in the remaining regions. This step can be performed by wet chemical etching in KOH or HF/HNO₃ etchants or preferably by plasma etching in CF₄, SF₆, or CHF₃ containing plasmas in RIE or ICP mode. Adding O₂ to the plasma process will yield in a cutting edge formation of the diamond film (as shown in step 9). Process details are disclosed for instance in DE 198 59 905 A1.

In FIG. 8, it is shown how the tip radius can be determined. The tip radius is determined by first drawing a line 60 bisecting the cross-sectional image of the first bevel of the cutting edge 1 in half. Where line 60 bisects the first bevel point 65 is drawn. A second line 61 is drawn perpendicular to line 60 at a distance of 110 nm from point 65. Where line 61 bisects the first bevel two additional points 66 and 67 are drawn. A circle 62 is then constructed from points 65, 66 and 67. The radius of circle 62 is the tip radius of the cutting edge 4.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cutting blade having a first face, a second face opposed to the first face and different from the first face as well as a cutting edge at the intersection of the first face and the second face, wherein:
the first face comprises a first surface;
the second face comprises a primary bevel, a secondary bevel and a tertiary bevel with
the primary bevel extending from the cutting edge to the secondary bevel;
the secondary bevel extending from the primary bevel to the tertiary bevel;
a first intersecting line connecting the primary bevel and the secondary bevel;
a second intersecting line connecting the secondary bevel and the tertiary bevel;
a first wedge angle θ₁ between the first surface and the primary bevel;
a second wedge angle θ₂ between the first surface and the secondary bevel;
a third wedge angle θ₃ between the first surface and the tertiary bevel;
the primary bevel having a length d₁ being the dimension projected onto the first surface and/or the imaginary extension of the first surface taken from the cutting edge to the first intersecting line from 0.1 to 7 μm;
a length d₂ being the dimension projected onto the first surface taken from the cutting edge to the second intersecting line from 1 to 150 μm; and
wherein θ₁>θ₂ and θ₂<θ₃.

2. The cutting blade of claim 1, wherein the first wedge angle θ₁ ranges from 5° to 75°, and/or the second wedge angle θ₂ ranges from −5° to 40°, and/or the third wedge angle θ₃ ranges from 1° to 60°.

3. The cutting blade of claim 1, wherein the primary bevel has a length d₁ being the dimension projected onto the first surface and/or the imaginary extension of the first surface taken from the cutting edge to the first intersecting line from 0.5 to 5 μm.

4. The cutting blade of claim 1, wherein the dimension projected onto the first surface and/or the imaginary extension of the first surface taken from the cutting edge to the second intersecting line has a length d₂ which ranges from 5 to 100 μm.

5. The cutting blade of claim 1, wherein the cutting blade comprises or consists of a blade body consisting of a first material or comprises or consists of a blade body comprising or consisting of a first material and a second material joined with the first material.

6. The cutting blade of claim 5, wherein the first material comprises a material selected from the group consisting of:
metals, or titanium, nickel, chromium, niobium, tungsten, tantalum, molybdenum, vanadium, platinum, germanium, iron, and alloys thereof, or steel;
ceramics comprising at least one element selected from the group consisting of carbon, nitrogen, boron, oxygen and combinations thereof, silicon carbide, zirconium oxide, aluminum oxide, silicon nitride, boron nitride, tantalum nitride, TiAlN, TiCN, and/or TiB₂;
glass ceramics or aluminum-containing glass-ceramics;
composite materials made from ceramic materials in a metallic matrix (cermets);
hard metals, preferably sintered carbide hard metals, such as tungsten carbide or titanium carbide bonded with cobalt or nickel;
silicon or germanium, or silicon or germanium with the crystalline plane parallel to the second face (2), wafer orientation <100>, <110>, <111>or <211>;
single crystalline materials;
glass or sapphire;
polycrystalline or amorphous silicon or germanium;
mono- or polycrystalline diamond, diamond like carbon (DLC), adamantine carbon; and
combinations thereof.

7. The cutting blade of claim 5, wherein the second material comprises a material selected from the group consisting of:
oxides, nitrides, carbides, borides, or aluminum nitride, chromium nitride, titanium nitride, titanium carbon nitride, titanium aluminum nitride, cubic boron nitride;
boron aluminum magnesium;
carbon, preferably diamond, poly-crystalline diamond, nano-crystalline diamond, diamond like carbon (DLC); and
combinations thereof.

8. The cutting blade of claim 5, wherein the second material fulfills at least one of the following properties:
a thickness of 0.15 to 20 μm;
a modulus of elasticity of less than 1200 GPa;
a transverse rupture stress σ₀ of at least 1 GPa; and
a hardness of at least 20 GPa.

9. The cutting blade of claim 5, wherein the second material comprises or consists of nano-crystalline diamond and fulfills at least one of the following properties:
an average surface roughness R_{RMS} of less than 100 nm; and
an average grain size d₅₀ of the nano-crystalline diamond of 1 to 100 nm.

10. The cutting blade of claim 5, wherein the first material and/or the second material are coated at least in regions with a low-friction material, wherein said low-friction material is selected from the group consisting of fluoropolymers, parylene, polyvinylpyrrolidone, polyethylene, polypropylene, polymethyl methacrylate, graphite, diamond-like carbon (DLC) and combinations thereof.

11. The cutting blade of claim 5, wherein the first intersecting line is shaped within the second material.

12. The cutting blade of claim 5, wherein the second intersecting line is arranged at a boundary surface of the first material and the second material.

13. The cutting blade of claim 1, wherein the cutting edge has a tip radius of less than 200 nm.

14. The cutting blade of claim 1, wherein the first face comprises a first surface which is planar.
The cutting blade of claim 1, wherein the first face further comprises a quaternary bevel extending from the cutting edge to the first surface.

15. A hair removal device comprising a cutting blade comprising a first face, a second face opposed to the first face and different from the first face as well as a cutting edge at the intersection of the first face and the second face, wherein
the first face comprises a first surface;
the second face comprises a primary bevel, a secondary bevel and a tertiary bevel with:
1. the primary bevel extending from the cutting edge to the secondary bevel;
2. the secondary bevel extending from the primary bevel to the tertiary bevel;
3. a first intersecting line connecting the primary bevel and the secondary bevel;
4. a second intersecting line connecting the secondary bevel and the tertiary bevel;
5. a first wedge angle θ₁ between the first surface and the primary bevel;
6. a second wedge angle θ₂ between the first surface and the secondary bevel;
7. a third wedge angle θ₃ between the first surface and the tertiary bevel;
8. the primary bevel having a length d₁ being the dimension projected onto the first surface and/or the imaginary extension of the first surface taken from the cutting edge to the first intersecting line from 0.1 to 7 μm;
9. a length d₂ being the dimension projected onto the first surface taken from the cutting edge to the second intersecting line from 1 to 150 μm; and
10. wherein θ₁>θ₂ and θ₂<θ₃.
